(19) United States
(12) Patent Application Publication
(10) Pub. No.: US 2026/0070414 A1
(43) Pub. Date: Mar. 12, 2026

(54) VEHICLE DISPLAY DEVICE, METHOD OF CONTROLLING VEHICLE DISPLAY DEVICE, AND STORAGE MEDIUM

(71) Applicant: HONDA MOTOR CO., LTD., Tokyo (JP)

(72) Inventor: Takashi Noguchi, Tokyo (JP)

(21) Appl. No.: 19/302,211

(22) Filed: Aug. 18, 2025

(30) Foreign Application Priority Data
Sep. 9, 2024 (JP) 2024-155063

(51) Int. Cl. B60K 35/29; B60K 35/22; B60K 35/28; B60K 35/81

(52) U.S. Cl. CPC B60K 35/29; B60K 35/22; B60K 35/28; B60K 35/81; B60K 2360/119; B60K 2360/164; B60K 2360/1868; B60K 2360/595; B60K 2360/741

(57) ABSTRACT

A vehicle display device includes: a display control unit configured to display an icon indicating details of content available in a vehicle by a display unit provided inside the vehicle; a passenger detection unit configured to detect a passenger of the vehicle; and a storage unit configured to store passenger information regarding the passenger of the vehicle, and the display control unit acquires the passenger information corresponding to the passenger detected by the passenger detection unit from the storage unit, and displays the icon based on the acquired passenger information and content information regarding the content.

### INCORPORATION BY REFERENCE

The present application claims priority under 35 U.S.C. § 119 to Japanese Patent Application No. 2024-155063 filed on Sep. 9, 2024. The content of the application is incorporated herein by reference in its entirety.

### BACKGROUND OF THE INVENTION

### Field of the Invention

The present invention relates to a vehicle display device, a method of controlling the vehicle display device, and a storage medium.

### Description of the Related Art

Conventionally, technology of displaying icons according to a preference of a user is known. For example, Japanese Patent Laid-Open No. 2023-058427 discloses a vehicle human machine interface (HMI) which dynamically adjusts display of icons according to a preference of a user based on a using pattern of one or more selectable icons.

In a vehicle HMI, an icon indicating details of content is displayed regarding the content available in a vehicle. However, since a passenger of the vehicle is not always the same passenger every time, regarding display of an icon indicating details of content, it cannot be said unconditionally that display should be performed based on an icon using pattern of the passenger as in Japanese Patent Laid-Open No. 2023-058427. Therefore, there is room for improvement with respect to appropriate display of an icon indicating details of content.

The present invention is implemented in consideration of the circumstances described above, and an object thereof is to appropriately display an icon indicating details of content according to a passenger of a vehicle.

### SUMMARY OF THE INVENTION

One aspect of the present invention is a vehicle display device includes: a display control unit configured to display an icon indicating details of content available in a vehicle by a display unit provided inside the vehicle; a passenger detection unit configured to detect a passenger of the vehicle; and a storage unit configured to store passenger information regarding the passenger of the vehicle, and the display control unit acquires the passenger information corresponding to the passenger detected by the passenger detection unit from the storage unit, and displays the icon based on the acquired passenger information and content information regarding the content.

According to an aspect of the present invention, an icon indicating details of content can be appropriately displayed according to a passenger of a vehicle.

### BRIEF DESCRIPTION OF THE DRAWINGS

FIG. 1 is a diagram illustrating a configuration of a content output system;

FIG. 2 is a diagram illustrating a configuration of a vehicle display device;

FIG. 3 is a diagram illustrating an example of a selection screen;

FIG. 4 is a flowchart illustrating an operation of the vehicle display device;

FIG. 5 is a diagram illustrating the configuration of the content output system; and

FIG. 6 is a diagram illustrating the configuration of the vehicle display device.

### DETAILED DESCRIPTION OF THE INVENTION

### 1. First Embodiment

First, with reference to the drawings, the first embodiment will be described.

### 1-1. Configuration of Content Output System

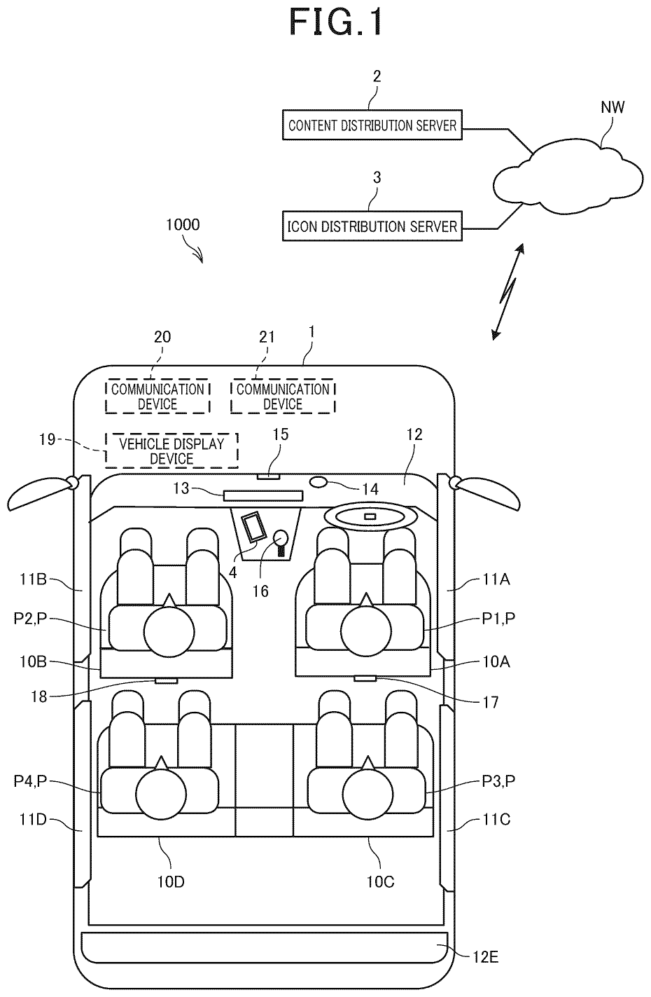

FIG. 1 is a diagram illustrating a configuration of a content output system 1000 according to the first embodiment.

The content output system 1000 is a system that outputs content inside a vehicle 1. Examples of the content output by the content output system 1000 include movies, still images, and music. The content output by the content output system 1000 is the content available inside the vehicle 1. Note that the content available inside the vehicle 1 also includes content distributed by a content distribution source with which a passenger P has made a contract.

As illustrated in FIG. 1, the content output system 1000 includes the vehicle 1, a content distribution server 2, and an icon distribution server 3.

Before describing the vehicle 1, the content distribution server 2 and the icon distribution server 3 will be described.

The content distribution server 2 is a server device that distributes content. The content distribution server 2 is connected to a network NW, and communicates with the vehicle 1. The network NW is a communication network formed of a public network, an exclusive line, and other communication circuits or the like.

The content output system 1000 may include the content distribution server 2 for each content distribution source. In addition, the content distribution server 2 may be a server device that integrally distributes the content distributed by a plurality of content distribution sources to the vehicle 1.

The icon distribution server 3 is a server device that distributes image data of an icon IC indicating details of content by a picture, a photo, characters, a symbol, or the like. The icon distribution server 3 is connected to the network NW, and communicates with the vehicle 1. The icon distribution server 3 stores a plurality of sets of a content ID (Identification) that identifies content and content information related to the content, and transmits the content information corresponding to the content ID transmitted from the vehicle 1 to the vehicle 1. The content information includes the image data of one or more icons IC. In addition, in the content information, one piece of detail information is associated with the image data of one icon IC. The detail information indicates details of the content indicated by the corresponding icon IC. Specifically, the detail information indicates a name of a person who is depicted in the icon IC and appears in the content, an expression of the person, a category of the content, a name of a composer or a lyricist or the like of the content, and a kind (violent, for example) of a picture or a photo or the like depicted in the icon IC.

In a case of movies, the categories of content are action movies, adventure movies, animation movies, documentary movies, horror movies, and the like. In the case of music, the categories of content are rock'n'roll, reggae, PHONK, trance, and the like. In the case of moving images, the categories of content are a distribution type, a merchandise introduction type, an entertainment type, a recitation type, and the like. Further, in the case of still images, the categories of content are Western painting, Oriental painting, and the like.

The vehicle 1 illustrated in FIG. 1 is a four-wheel vehicle. The vehicle 1 includes a driver's seat 10A, a front passenger seat 10B, a rear right seat 10C, and a rear left seat 10D. FIG. 1 illustrates a situation where a passenger P1 who is a driver is seated in the driver's seat 10A in the vehicle 1. In addition, FIG. 1 illustrates a situation where a passenger P2 who is a fellow passenger is seated in the front passenger seat 10B in the vehicle 1. Further, FIG. 1 illustrates a situation where a passenger P3 who is a fellow passenger is seated in the rear right seat 10C in the vehicle 1. Further, FIG. 1 illustrates a situation where a passenger P4 who is a fellow passenger is seated in the rear left seat 10D in the vehicle 1.

The vehicle 1 includes a right front door 11A, a left front door 11B, a right rear door 11C, a left rear door 11D, and a tailgate 11E. Opening the right front door 11A, the left front door 11B, the right rear door 11C, and the left rear door 11D makes it possible to get in and out of an interior space of the vehicle 1. The tailgate 11E opens and closes a trunk of the vehicle 1.

The vehicle 1 includes a dashboard 12. On the dashboard 12, a touch panel 13 and a speaker 14 are installed. The touch panel 13 is formed by superimposing or integrating a display panel that displays characters and images and a touch sensor that detects contact to the display panel.

The speaker 14 outputs sound to the interior space of the vehicle 1. An installation position and the number of the speakers 14 can be arbitrarily changed.

The touch panel 13 is an example of a “display unit”.

In the interior of the vehicle 1, a camera 15 that photographs the interior of the vehicle 1 is installed. A photographing range of the camera 15 is set to a range where it is possible to photograph the passenger P seated in the driver's seat 10A and the passenger P seated in the front passenger seat 10B. More specifically, the photographing range of the camera 15 is set to the range where it is possible to photograph heads (including faces) of the two passengers P.

The vehicle 1 includes a shift lever 16 installed near the driver's seat 10A.

A camera 17 is installed in the interior of the vehicle 1. The camera 17 is installed on a back surface of the driver's seat 10A for example, and photographs the passenger P seated in the rear right seat 10C. A photographing range of the camera 17 is set to a range where it is possible to photograph the passenger P seated in the rear right seat 10C. More specifically, the photographing range of the camera 17 is set to the range where it is possible to photograph the head (including the face) of the passenger P seated in the rear right seat 10C.

A camera 18 is installed in the interior of the vehicle 1. The camera 18 is installed on a back surface of the front passenger seat 10B for example, and photographs the passenger P seated in the rear left seat 10D. A photographing range of the camera 18 is set to a range where it is possible to photograph the passenger P seated in the rear left seat 10D. More specifically, the photographing range of the camera 18 is set to the range where it is possible to photograph the head (including the face) of the passenger P seated in the rear left seat 10D.

The vehicle 1 includes a vehicle display device 19. The vehicle display device 19 outputs the content distributed by the content distribution server 2, the content stored in a portable terminal 4, and the content received by the portable terminal 4 by at least one of the touch panel 13 and the speaker 14.

The vehicle display device 19 displays various kinds of information by the touch panel 13. In the present embodiment, the vehicle display device 19 displays a selection screen G for selecting the content that can be output.

The vehicle 1 includes a communication device 20. The communication device 20 includes hardware according to a predetermined communication standard such as a wireless communication circuit, and communicates with the content distribution server 2 and the icon distribution server 3 connected to the network NW.

The vehicle 1 includes a communication device 21. The communication device 21 includes hardware according to a predetermined communication standard such as a communication circuit, and communicates with the portable terminal 4. Note that the communication standard of the communication device 21 may be a cable communication standard or a wireless communication standard.

### 1-2. Configuration of Vehicle Display Device

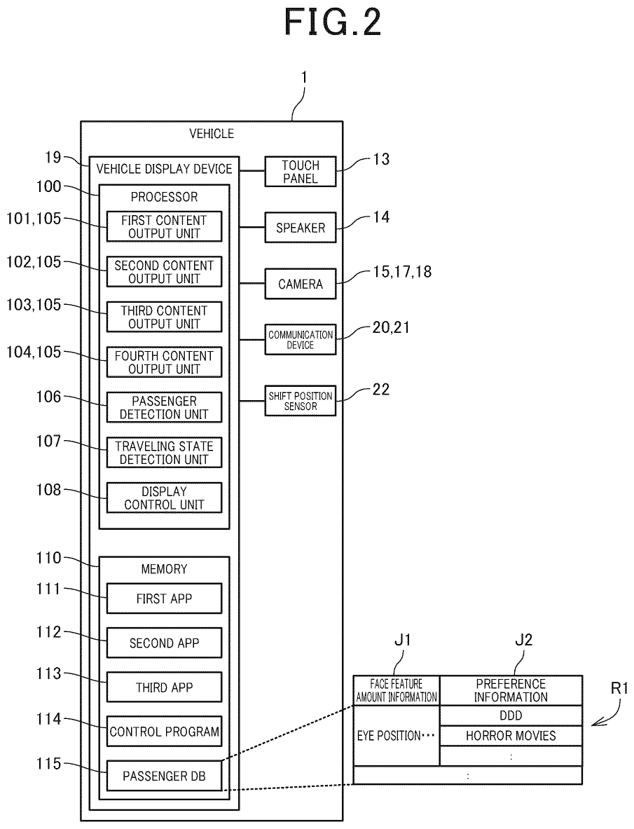

Next, with reference to FIG. 2, the configuration of the vehicle display device 19 will be described.

FIG. 2 is a diagram illustrating the configuration of the vehicle display device 19.

To the vehicle display device 19, the touch panel 13, the speaker 14, the camera 15, the camera 17, the camera 18, the communication device 20, the communication device 21, and a shift position sensor 22 are connected. Note that devices connected to the vehicle display device 19 are not limited to these devices and devices of other kinds may be connected further.

The touch panel 13 displays various kinds of information according to control of the vehicle display device 19.

The speaker 14 outputs various kinds of sound according to the control of the vehicle display device 19.

The cameras 15, 17, and 18 perform photographing in a predetermined cycle, and output photographed images obtained by the photographing to the vehicle display device 19.

The communication device 20 communicates with the vehicle display device 19, the content distribution server 2, and the icon distribution server 3.

The communication device 21 communicates with the vehicle display device 19 and the portable terminal 4.

The shift position sensor 22 detects a shift position of the shift lever 16 provided in the vehicle 1. The shift position is, for example, P (parking) used when stopping or parking the vehicle, R (reverse) used when moving backwards, N (neutral), and D (drive) used when traveling, or the like.

The vehicle display device 19 includes a processor 100 such as a CPU (Central Processing Unit) and an MPU (Micro Processor Unit), a memory 110, and an interface circuit for connecting other devices and sensors.

The memory 110 is an example of a “storage unit”.

The memory 110 is a storage device that stores programs and data. The memory 110 stores a first APP 111, a second APP 112, a third APP 113, a control program 114, a passenger DB (database) 115, and data processed by the processor 100. The memory 110 includes a nonvolatile storage area. In addition, the memory 110 may include a volatile storage area and configure a work area of the processor 100. The memory 110 is formed of a ROM (Read Only Memory) and a RAM (Random Access Memory) for example.

The control program 114 is an example of a “program”.

The first APP 111 is an application program for utilizing content distributed by one content distribution source.

The second APP 112 is an application program for utilizing content distributed by a content distribution source different from that of the first APP 111.

The third APP 113 is an application program for utilizing content distributed by a content distribution source different from that of the first APP 111 and the second APP 112.

The control program 114 is a program that makes the processor 100 function as functional units to be described later.

The passenger DB 115 is a database having one piece of passenger information R1 for each passenger P. One piece of passenger information R1 includes face feature amount information J1, and one or more pieces of preference information J2.

The passenger information R1 is created in advance and is registered in the passenger DB 115.

The face feature amount information J1 is information that indicates a face feature amount of the passenger P. The face feature amount indicates a feature amount of a face formed of a plurality of items such as a position of a feature point of an eye, a position of a feature point of a nose, a position of a feature point of a mouth, and a size of a face area.

The preference information J2 is information that indicates a target of a preference related to the content. One piece of the preference information J2 indicates one target of the preference. For the preference information J2, the category of the preferred content and a name of a preferred person such as an actor, an actress, a singer, a performer, a composer and a lyricist or the like are recorded as the information. While a name including an honorific is exemplified as a name of a person in FIG. 2, a name of a person indicated by the preference information J2 may not include an honorific.

The processor 100 functions as a first content output unit 101 by reading and executing the first APP 111 stored in the memory 110.

The first content output unit 101 receives the content of the content distribution source corresponding to the first APP 111 from the content distribution server 2 via the communication device 20, and outputs the received content by at least one of the touch panel 13 and the speaker 14.

The processor 100 functions as a second content output unit 102 by reading and executing the second APP 112 stored in the memory 110.

The second content output unit 102 receives the content of the content distribution source corresponding to the second APP 112 from the content distribution server 2 via the communication device 20, and outputs the received content by at least one of the touch panel 13 and the speaker 14.

The processor 100 functions as a third content output unit 103 by reading and executing the third APP 113 stored in the memory 110.

The third content output unit 103 receives the content of the content distribution source corresponding to the third APP 113 from the content distribution server 2 via the communication device 20, and outputs the received content by at least one of the touch panel 13 and the speaker 14.

The first content output unit 101 to the third content output unit 103 receive the content information for each content that can be output prior to the display of the selection screen G. The content information received by the first content output unit 101 to the third content output unit 103 includes the image data of one or more icons IC. In addition, in the content information, the detail information is associated with each piece of the image data of the icon IC.

The processor 100 functions as the fourth content output unit 104, a passenger detection unit 106, a traveling state detection unit 107, and a display control unit 108 by reading and executing the control program 114 stored in the memory 110.

### 1-3. Fourth Content Output Unit

The fourth content output unit 104 outputs at least either of the content stored in the portable terminal 4 and the content received by the portable terminal 4 by at least one of the touch panel 13 and the speaker 14.

The fourth content output unit 104 receives the content from the portable terminal 4 via the communication device 21, and outputs the received content. The fourth content output unit 104 receives the content ID (Identification) from the portable terminal 4 via the communication device 21 for each content that can be received from the portable terminal 4.

When the content ID is received from the portable terminal 4, the fourth content output unit 104 transmits the received content ID to the icon distribution server 3 via the communication device 20. Then, the fourth content output unit 104 receives the content information from the icon distribution server 3 for each transmitted content ID.

Hereinafter, the first content output unit 101 to the fourth content output unit 104 are denoted by a reference numeral “105” and expressed as “content output units 105”, when not to be distinguished from each other.

### 1-4. Configuration of Passenger Detection Unit

The passenger detection unit 106 detects the passenger P of the vehicle 1.

In the present embodiment, the passenger detection unit 106 detects the passenger P based on the photographed images received from the cameras 15, 17 and 18. The passenger detection unit 106 detects an image of a face by a method of pattern matching or the like for each of the received photographed images. The passenger detection unit 106 detects the passenger P by detecting the image of the face.

When the image of the face is detected, that is, when the passenger P is detected, the passenger detection unit 106 calculates the face feature amount for each detected passenger P. Note that the face feature amount is calculated based on, for example, a size of the image of the face in the photographed image, the position of the feature point of the eye, the position of the feature point of the noise, and the position of the feature point of the mouth in the image of the face, or the like.

When the passenger P of the vehicle 1 is detected, the passenger detection unit 106 detects a seated position of the passenger P for each detected passenger P.

For example, when the image of the face is detected on a left side from a center in the photographed image of the camera 15, the passenger detection unit 106 detects the seated position of the passenger P corresponding to the image of the face as the driver's seat 10A.

In addition, for example, when the image of the face is detected on a right side from the center in the photographed image of the camera 15, the passenger detection unit 106 detects the seated position of the passenger P corresponding to the image of the face as the front passenger seat 10B.

Further, for example, when the image of the face is detected from the photographed image of the camera 17, the passenger detection unit 106 detects the seated position of the passenger P corresponding to the image of the face as the rear right seat 10C.

Further, for example, when the image of the face is detected from the photographed image of the camera 18, the passenger detection unit 106 detects the seated position of the passenger P corresponding to the image of the face as the rear left seat 10D.

### 1-5. Configuration of Traveling State Detection Unit

The traveling state detection unit 107 detects a traveling state of the vehicle 1. The traveling state detection unit 107 detects whether or not the vehicle 1 is in a manual traveling state. The manual traveling state is a state where the passenger P seated in the driver's seat 10A is manually driving. For example, when the shift position sensor 22 detects R (reverse), N (neutral) or D (drive), the traveling state detection unit 107 detects that the vehicle 1 is in the manual traveling state. Further, for example, when the shift position sensor 22 detects P (parking), the traveling state detection unit 107 detects that the vehicle 1 is not in the manual traveling state. The fact that the vehicle 1 is not in the manual traveling state may include the fact that the vehicle 1 is in an automatic traveling state. The automatic traveling state means that the vehicle 1 is traveling even though the passenger P seated in the driver's seat 10A is not manually driving.

### 1-6. Configuration of Display Control Unit

The display control unit 108 displays the selection screen G by the touch panel 13. While details will be described later, the selection screen G displays one icon IC for each piece of content.

Note that one piece of content is, for example, a piece of music, one movie, one moving image, or one still image.

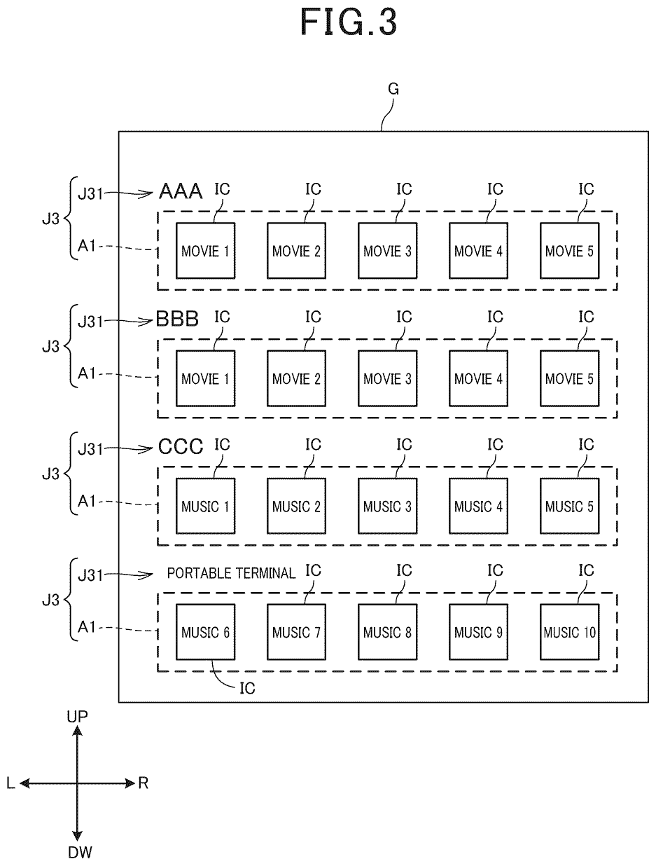

FIG. 3 is a diagram illustrating an example of the selection screen G.

In FIG. 3, an upward direction in the figure is indicated with a sign UP, a downward direction in the figure is indicated with a sign DW, a direction toward left in the figure is indicated with a sign L, and a direction toward right in the figure is indicated with a sign R. The four up, down, left, and right directions correspond to the four up, down, left, and right directions in the state of the passenger P who visually recognizes the selection screen G.

The selection screen G includes content related information J3 for each content supply source. The content related information J3 includes name information J31 and a list display area A1. Note that the content supply source includes the content distribution source and the portable terminal 4 or the like.

The name information J31 is information that indicates a name of the content supply source.

The list display area A1 is an area that displays a list of the content supplied by the content supply source indicated by the name information J31, and displays one icon IC for one piece of the content.

While the list display area A1 illustrated in FIG. 3 is configured to display the plurality of icon IC in a left-right direction in one row, the list display area A1 may be configured to display the plurality of icon IC in the left-right direction in a plurality of rows. Further, the list display area A1 may be configured to, when a predetermined touch operation (a flick operation or a slide operation) is performed inside the list display area A1, display other icon IC that have not been displayed before the predetermined touch operation is performed.

The selection screen G illustrated in FIG. 3 is configured such that the content of four content supply sources can be selected on one screen. However, a screen configuration of the selection screen G is not limited to the configuration illustrated in FIG. 3. For example, the selection screen G may be formed of a plurality of screens and may be configured such that the content of one or more content supply sources can be selected on one screen. In the case of this example, when the predetermined touch operation (the flick operation or the slide operation) is performed in an area other than the list display area A1 on the selection screen G, the selection screen G switches the screen that displays the content to the screen that displays the content of another content supply source.

The icons IC displayed in the list display area A1 differ depending on whether or not the passenger information R1 of all the passengers P detected by the passenger detection unit 106 is stored in the memory 110.

When the passenger information R1 of all the passengers P detected by the passenger detection unit 106 is not stored in the memory 110, the icons IC displayed in the list display area A1 are the icons IC not based on the passenger information R1.

On the other hand, when the passenger information R1 of all the passengers P detected by the passenger detection unit 106 is stored in the memory 110, the icons IC displayed in the list display area A1 are the icons IC based on the passenger information R1 of the passengers P detected by the passenger detection unit 106.

Hereinafter, the selection screen G where the icons IC not based on the passenger information R1 are displayed is referred to as a “first selection screen”, and the selection screen G where the icons IC based on the passenger information R1 are displayed is referred to as a “second selection screen”.

### 1-6-1. First Selection Screen

The first selection screen will be described in detail.

On the first selection screen, the icons IC not based on the passenger information R1 are displayed in the list display area A1. The icon IC not based on the passenger information R1 is the icon IC selected from the icons IC included in the content information without taking the preference information J2 included in the passenger information R1 into consideration.

Here, processing related to display of the first selection screen by the display control unit 108 will be described.

The display control unit 108 determines whether or not the passenger information R1 corresponding to the passenger P is stored in the memory 110 for each passenger P detected by the passenger detection unit 106.

More specifically, the display control unit 108 of the present embodiment acquires the face feature amount from the passenger detection unit 106 for each passenger P, and determines whether or not the passenger information R1 including the face feature amount with a concordance rate with the acquired face feature amount being a threshold or higher is present for each passenger P. Then, the display control unit 108 determines that the passenger information R1 corresponding to the passenger P is stored when it is determined that the relevant passenger information R1 is present, and determines that the passenger information R1 corresponding to the passenger P is not stored when it is determined that the relevant passenger information R1 is not present.

Then, when the passenger P for whom the passenger information R1 is not stored in the memory 110 is included in the passengers P detected by the passenger detection unit 106, the display control unit 108 displays the first selection screen by the touch panel 13.

When displaying the first selection screen, the display control unit 108 performs following processing for each content supply source.

That is, the display control unit 108 selects a plurality of pieces of content information that can be supplied by the content supply source. Selection is made at random. Next, the display control unit 108 acquires the icon IC from each of the selected content information. The icon IC may be acquired at random or the detail information may be referred to acquire the icon IC other than a predetermined depiction (for example, a violent depiction). Then, the display control unit 108 generates the content related information J3 including the list display area A1 where the acquired icons IC are lined up and the name information J31, and includes the generated content related information J3 in the first selection screen.

### 1-6-2. Second Selection Screen

The second selection screen will be described in detail.

On the second selection screen, the icons IC based on the passenger information R1 are displayed in the list display area A1. The icon IC based on the passenger information R1 is the icon IC selected from the content information in consideration of the preference information J2 included in the passenger information R1.

When one passenger P is detected by the passenger detection unit 106, the icons IC are displayed as follows in the list display area A1 on the second selection screen.

That is, in the list display area A1 on the second selection screen, the icon IC based on the preference information J2 included in the passenger information R1 of the detected passenger P is displayed regarding one piece of content.

For example, it is assumed that the passenger information R1 of the detected passenger P includes the preference information J2 indicating “DDD” as a name of an actor, the preference information J2 indicating “horror movies” as the category of the content, and the preference information J2 indicating “EEE” as a name of an actress.

In the case of this example, in the list display area A1 that displays the content of movies, the icon IC indicating the actor “DDD” is displayed regarding certain content, the icon IC indicating a person with an expression of fear is displayed for other content different from the certain content, and the icon IC indicating an actress “EEE” is displayed regarding other content further.

When the plurality of passengers P are detected by the passenger detection unit 106, the icons IC are displayed as follows in the list display area A1 on the second selection screen.

That is, in the list display area A1 on the second selection screen, when there are a plurality of targets of the preference that match among the passengers P detected by the passenger detection unit 106, the icon IC is displayed based on the preference information J2 indicating the target of the preference with the highest number of matches regarding one piece of content. When the target of the preference does not coincide among the passengers P detected by the passenger detection unit 106, the icon IC similar to that when one passenger P is detected by the passenger detection unit 106 is displayed.

For example, it is assumed that the passengers P1, P2, P3, and P4 are detected. In addition, in this example, it is assumed that the passenger information R1 of the passenger P1 includes the preference information J2 indicating “DDD” as a name of an actor and the preference information J2 indicating “horror movies” as the category of the content. Further, in this example, it is assumed that the passenger information R1 of the passenger P2 includes the preference information J2 indicating “DDD” as a name of an actor and the preference information J2 indicating “action movies” as the category of the content. In this example, it is assumed that the passenger information R1 of the passenger P3 includes the preference information J2 indicating “DDD” as a name of an actor and the preference information J2 indicating “adventure movies” as the category of the content. Further, in this example, it is assumed that the passenger information R1 of the passenger P4 includes the preference information J2 indicating “EEE” as a name of an actor.

In the case of this example, the target of the preference with the highest number of matches among the passengers P1, P2, P3, and P4 is the name “DDD”.

Therefore, in the case of this example, in the list display area A1 that displays the content of movies, the icon IC indicating the actor of the name “DDD” is displayed.

Further, when the plurality of passengers P are detected by the passenger detection unit 106, the icons IC are displayed as follows in the list display area A1 on the second selection screen.

That is, priority for displaying the icon IC is set for each passenger information R1, and the icon IC is displayed based on the priority set for each passenger information R1 in the list display area A1 on the second selection screen.

Note that the priority is set based on the seated position of the passenger P detected by the passenger detection unit 106 and the traveling state of the vehicle 1 detected by the traveling state detection unit 107.

When the traveling state of the vehicle 1 is not the manual traveling state, the priority is set as follows. That is, the priority for the passenger P in the driver's seat 10A is set to be higher than the priority for the passengers P in seats other than the driver's seat 10A.

When the traveling state of the vehicle 1 is not the manual traveling state, in the list display area A1 on the second selection screen, the icon IC based on the passenger information R1 of the passenger P in the driver's seat 10A is displayed preferentially to the icon IC based on the passenger information R1 of the passengers P in the seats other than the driver's seat 10A. In the list display area A1 on the second selection screen, when the plurality of passengers P are in the seats other than the driver's seat 10A and there is a target of the preference that matches among the passengers P in the seats other than the driver's seat 10A, the icon IC is displayed based on the number of matches of the target of the preference described above, regarding the passengers P in the seats other than the driver's seat 10A.

In the present embodiment, displaying preferentially means displaying on a left side in the left-right direction of the selection screen G. Note that, in the list display area A1, when there is an icon IC that is not displayed, displaying preferentially means displaying on the left side in the left-right direction of the selection screen G and also displaying so as to reduce an operation amount of a touch operation for displaying in the list display area A1.

For example, it is assumed that the passengers P1, P2, and P3 are detected. In addition, in this example, it is assumed that the passenger information R1 of the passenger P1 includes the preference information J2 indicating “DDD” as a name of an actor. In addition, in this example, it is assumed that the passenger information R1 of the passenger P2 includes the preference information J2 indicating “EEE” as a name of an actor and the preference information J2 indicating “action movies” as the category of the content. Further, in this example, it is assumed that the passenger information R1 of the passenger P3 includes the preference information J2 indicating “EEE” as a name of an actor and the preference information J2 indicating “horror movies” as the category of the content. Further, in this example, it is assumed that the vehicle 1 is not in the manual traveling state.

In the case of this example, in the list display area A1 on the second selection screen related to the content of movies, the icon IC indicating the actor of the name “DDD” preferred by the passenger P1 is preferentially displayed. In addition, in the case of this example, in the list display area A1 on the second selection screen related to the content of movies, the icon IC indicating the actor of the name “EEE” preferred by both passengers P2 and P3 is displayed next preferentially to the icon IC indicating the actor of the name “DDD”. Note that the icon IC indicating the actor of the name “DDD” and the icon IC indicating the actor of the name “EEE” are different content.

When the traveling state of the vehicle 1 is the manual traveling state, the priority is set as follows. That is, the priority for the passenger P in the driver's seat 10A is set to be lower than the priority for the passengers P in the seats other than the driver's seat 10A.

In this case, in each list display area A1 on the second selection screen, the icon IC based on the passenger information R1 of the passengers P in the seats other than the driver's seat 10A is displayed preferentially to the icon IC based on the passenger information R1 of the passengers P in the driver's seat 10A. In the list display area A1 on the second selection screen, when the plurality of passengers P are in the seats other than the driver's seat 10A and there is a target of the preference that matches among the passengers P in the seats other than the driver's seat 10A, the icon IC is displayed based on the number of matches of the target of the preference described above, regarding the passengers P in the seats other than the driver's seat 10A.

For example, it is assumed that the passengers P1, P2, and P3 are detected. In addition, in this example, it is assumed that the passenger information R1 of the passenger P1 includes the preference information J2 indicating “DDD” as a name of an actor.

In addition, in this example, it is assumed that the passenger information R1 of the passenger P2 includes the preference information J2 indicating “EEE” as a name of an actor and the preference information J2 indicating “horror movies” as the category of the content. Further, in this example, it is assumed that the passenger information R1 of the passenger P3 includes the preference information J2 indicating “DDD” as a name of an actor and the preference information J2 indicating “horror movies” as the category of the content. Further, in this example, it is assumed that the vehicle 1 is in the manual traveling state.

In the case of this example, the target of the preference that matches between the passengers P2 and P3 is the category of “horror movies”. Therefore, in the list display area A1 on the second selection screen, the icon IC indicating a person with an expression of fear is displayed preferentially to the icon IC based on the passenger information R1 of the passenger P1.

Here, processing related to the display of the second selection screen by the display control unit 108 will be described.

As described above, the display control unit 108 determines whether or not the passenger information R1 corresponding to the passenger P is stored in the memory 110 for each passenger P detected by the passenger detection unit 106. Then, when the passenger information R1 of all the passengers P detected by the passenger detection unit 106 is stored in the memory 110, the display control unit 108 displays the second selection screen by the touch panel 13.

When displaying the second selection screen, the display control unit 108 sets the priority based on the seated position of the passenger P detected by the passenger detection unit 106 and the traveling state of the vehicle 1 detected by the traveling state detection unit 107 for each passenger information R1 of the passenger P detected by the passenger detection unit 106.

Next, when the priority is set, the display control unit 108 executes the following processing for each content supply source.

That is, the display control unit 108 reads the preference information J2 from the passenger information R1. Then, the display control unit 108 specifies the target of the preference that matches among the passengers P in the seats other than the driver's seat 10A based on the preference information J2 of the passengers P in the seats other than the driver's seat 10A.

Next, when the target of the preference that matches is specified, the display control unit 108 refers to each detail information of the content information received by the content output unit 105, and reads the icon IC indicating the details of the content corresponding to the preference information J2 of the passenger P in the driver's seat 10A and the icon IC indicating the details of the content corresponding to the preference information J2 indicating the specified target of the preference.

On the other hand, when the target of the preference that matches cannot be specified, the display control unit 108 refers to each detail information of the content information received by the content output unit 105, and reads the icon IC indicating the details of the content corresponding to the preference information J2 of each passenger P.

Next, the display control unit 108 generates the content related information J3 including the list display area A1 where the icons IC are lined up based on the priority set to the passenger information R1 and the name information J31, and includes the generated content related information J3 in the second selection screen.

For example, when the preference information J2 indicates the name “DDD”, the icon IC indicating the details of the content corresponding to the preference information J2 is the icon IC associated with the detail information indicating the name “DDD”. In addition, for example, when the preference information J2 indicates the category “horror movies”, the icon IC indicating the details of the content corresponding to the preference information J2 is the icon IC associated with the detail information indicating the category “horror movies” or the detail information indicating the expression “fear” of a person. Further, for example, when the preference information J2 indicates “action movies”, the icon IC indicating the details of the content corresponding to the preference information J2 is the icon IC indicating a person who performs physical activities.

### 1-7. Operation of Vehicle Display Device

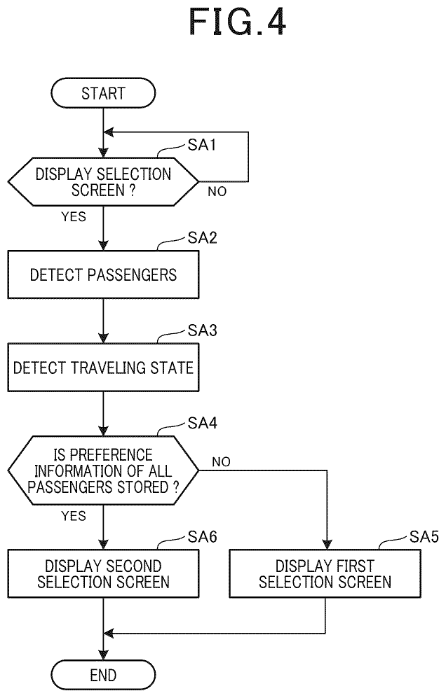

Next, with reference to FIG. 4, the operation of the vehicle display device 19 regarding the display of the icon IC will be described.

FIG. 4 is a flowchart illustrating the operation of the vehicle display device 19.

The display control unit 108 determines whether or not to display the selection screen G (step SA1).

For example, if the passenger P inputs an instruction to display a list of the content to the touch panel 13, the display control unit 108 makes an affirmative determination in step SA1.

If it is determined not to display the selection screen G (step SA1: NO), the display control unit 108 makes a determination in step SA1 again.

On the other hand, if the display control unit 108 determines to display the selection screen G (step SA1: YES), the passenger detection unit 106 detects the passengers P riding in the vehicle 1 (step SA2).

Next, the traveling state detection unit 107 detects the traveling state of the vehicle 1 (step SA3).

Note that a processing order of steps SA2 and SA3 may be reversed. Further, steps SA2 and SA3 may be simultaneously executed.

Next, the display control unit 108 determines whether or not the preference information J2 of all the passengers P detected in step SA2 is stored in the memory 110 (step SA4).

If it is determined that the preference information J2 of all the passengers P detected in step SA2 is not stored in the memory 110 (step SA4: NO), the display control unit 108 displays the first selection screen by the touch panel 13 (step SA5).

When one icon IC is selected by a touch operation on the first selection screen, the content output unit 105 outputs the content corresponding to the selected icon IC. That is, if the content corresponding to the selected icon IC is the content distributed by the first APP 111, the first content output unit 101 receives and outputs the content corresponding to the selected icon IC. In addition, if the content corresponding to the selected icon IC is the content distributed by the second APP 112, the second content output unit 102 receives and outputs the content corresponding to the selected icon IC. Further, if the content corresponding to the selected icon IC is the content distributed by the third APP 113, the third content output unit 103 receives and outputs the content corresponding to the selected icon IC. Further, if the content corresponding to the selected icon IC is the content that can be received from the portable terminal 4, the fourth content output unit 104 receives and outputs the content corresponding to the selected icon IC.

On the other hand, if it is determined that the preference information J2 of all the passengers P detected in step SA2 is stored in the memory 110 (step SA4: YES), the display control unit 108 displays the second selection screen by the touch panel 13 (step SA6).

When one icon IC is selected by a touch operation on the second selection screen, the content output unit 105 outputs the content corresponding to the selected icon IC, similarly to the first selection screen.

### 2. Second Embodiment

Next, the second embodiment will be described.

In the description of the second embodiment, components same as the components of the first embodiment are denoted by the same reference signs and the detailed description is appropriately omitted.

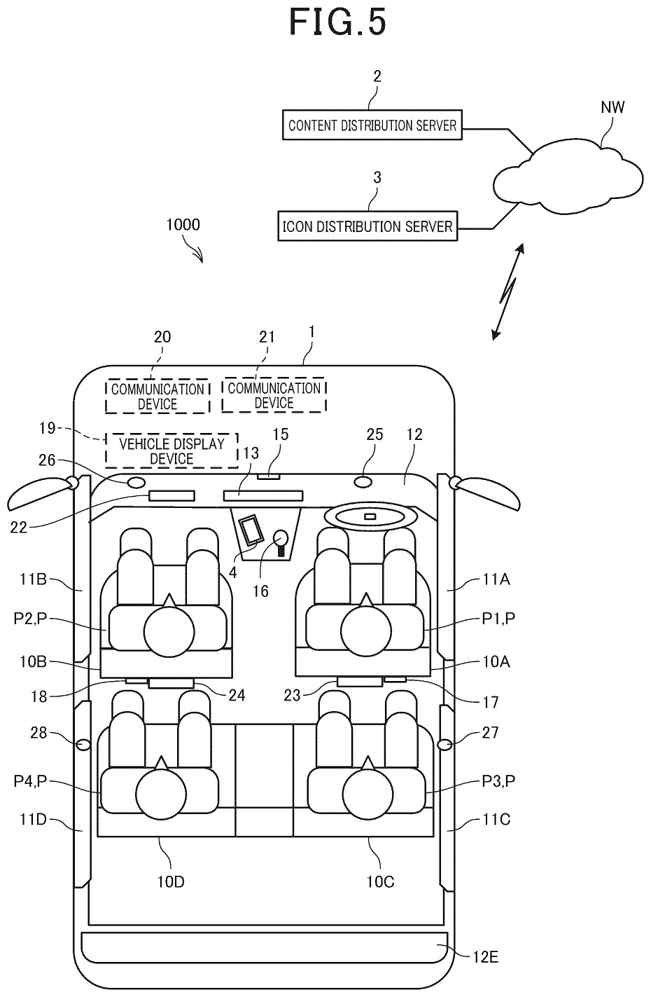

FIG. 5 is a diagram illustrating the configuration of the content output system 1000 according to the second embodiment.

As is clear from a comparison between FIG. 5 and FIG. 1, the vehicle 1 of the second embodiment includes touch panels 22, 23, and 24.

In addition, as is clear from the comparison between FIG. 5 and FIG. 1, the vehicle 1 of the second embodiment includes speakers 25, 26, 27, and 28.

The touch panels 22, 23, and 24 are examples of the “display unit”.

Each of the touch panels 22, 23, and 24 is formed by superimposing or integrating a display panel that displays characters and images and a touch sensor that detects contact to the display panel. The touch panel 22 is installed more on the side of the front passenger seat 10B than the touch panel 13 on the dashboard 12. The touch panel 23 is installed at a position to be visually recognized by the passenger P seated in the rear right seat 10C, on a back surface of the driver's seat 10A for example. The touch panel 24 is installed at a position to be visually recognized by the passenger P seated in the rear left seat 10D, on a back surface of the front passenger seat 10B for example.

The speaker 25 outputs sound to the passenger P seated in the driver's seat 10A. The speaker 26 outputs sound to the passenger P seated in the front passenger seat 10B. The speaker 27 outputs sound to the passenger P seated in the rear right seat 10C. The speaker 28 outputs sound to the passenger P seated in the rear left seat 10D. Note that installation positions of the speakers 25, 26, 27, and 28 are not limited to those in FIG. 5 and may be positions from which sound can be output to the passenger P seated in the corresponding seat.

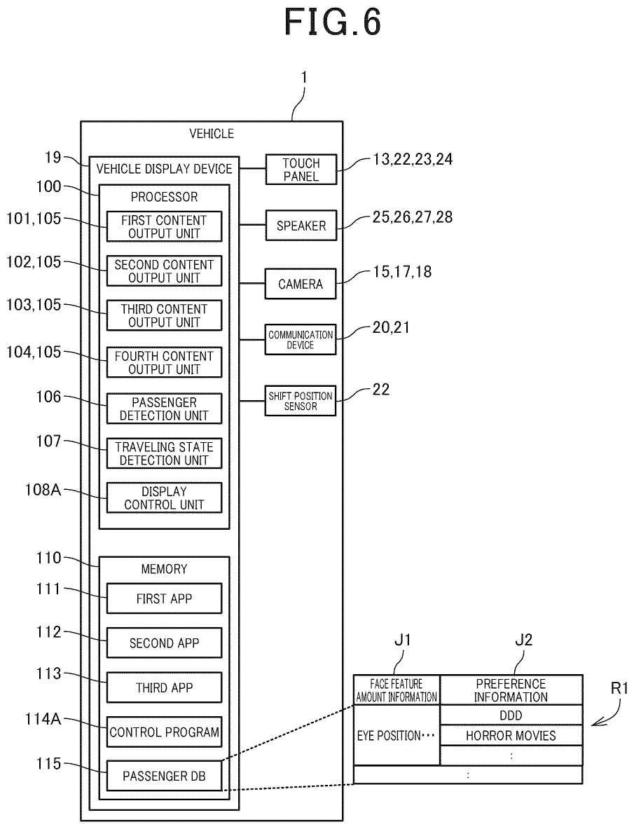

FIG. 6 is a diagram illustrating the configuration of the vehicle display device 19 according to the second embodiment.

As is clear from the comparison between FIG. 6 and FIG. 2, to the vehicle display device 19, the touch panels 22, 23, and 24 are connected, and the speakers 25, 26, 27, and 28 are connected.

Further, as is clear from the comparison between FIG. 6 and FIG. 2, the memory 110 stores a control program 114A instead of the control program 114.

The control program 114A is an example of the “program”.

The control program 114A is a program that makes the processor 100 function as the passenger detection unit 106, the traveling state detection unit 107, and a display control unit 108A.

The display control unit 108A displays the selection screen G by each of the touch panels 13, 22, 23, and 24.

When the passenger P for whom the preference information J2 is not stored in the memory 110 is included in the passengers P detected by the passenger detection unit 106, the display control unit 108A displays the first selection screen by each of the touch panels 13, 22, 23, and 24.

When the preference information J2 of all the passengers P detected by the passenger detection unit 106 is stored in the memory 110, the display control unit 108A displays the second selection screen by each of the touch panels 13, 22, 23, and 24. In this case, the display control unit 108A sets the priority for displaying the icon IC for each of the touch panels 13, 22, 23, and 24, and displays the second selection screen based on the set priority.

More specifically, the display control unit 108A sets the priority for the passenger information R1 of the passenger P (hereinafter referred to as a “target passenger”) seated in a corresponding seat to be higher than the priority for the passenger information R1 of the passengers P different from the target passenger for each of the touch panels 13, 22, 23, and 24.

Then, the display control unit 108A displays the icon IC based on the set priority and the preference information J2 of the passenger P for each of the touch panels 13, 22, 23, and 24.

For the touch panel 13, the display control unit 108A sets the priority to be set for the passenger information R1 of the passenger P seated in the driver's seat 10A to be higher than the priority to be set for the passenger information R1 of the passengers P seated in the seats other than the driver's seat 10A. Thus, for example, when the passengers P1, P2, P3, and P4 are detected as illustrated in FIG. 1, on the second selection screen displayed by the touch panel 13, in the list display area A1, the icon IC based on the passenger information R1 of the passenger P1 is most preferentially displayed, and the icons IC based on the passenger information R1 of the other passengers P are next preferentially displayed.

For the touch panel 22, the display control unit 108A sets the priority to be set for the passenger information R1 of the passenger P seated in the front passenger seat 10B to be higher than the priority to be set for the passenger information R1 of the passengers P seated in the seats other than the front passenger seat 10B. Thus, for example, when the passengers P1, P2, P3, and P4 are detected as illustrated in FIG. 1, on the second selection screen displayed by the touch panel 22, the icon IC based on the passenger information R1 of the passenger P2 is most preferentially displayed, and the icons IC based on the passenger information R1 of the other passengers P are next preferentially displayed.

For the touch panel 23, the display control unit 108A sets the priority to be set for the passenger information R1 of the passenger P3 seated in the rear right seat 10C to be higher than the priority to be set for the passenger information R1 of the passengers P seated in the seats other than the rear right seat 10C. Thus, for example, when the passengers P1, P2, P3, and P4 are detected as illustrated in FIG. 1, on the second selection screen displayed by the touch panel 23, the icon IC based on the passenger information R1 of the passenger P3 is most preferentially displayed, and the icons IC based on the passenger information R1 of the other passengers P are next preferentially displayed.

For the touch panel 24, the display control unit 108A sets the priority to be set for the passenger information R1 of the passenger P4 seated in the rear left seat 10D to be higher than the priority to be set for the passenger information R1 of the passengers P seated in the seats other than the rear left seat 10D. Thus, for example, when the passengers P1, P2, P3, and P4 are detected as illustrated in FIG. 1, on the second selection screen displayed by the touch panel 24, the icon IC based on the passenger information R1 of the passenger P4 is displayed preferentially to the icons IC based on the passenger information R1 of the other passengers P.

Next, the operation of the vehicle display device 19 of the present embodiment will be described with reference to FIG. 5.

The vehicle display device 19, after performing steps SA1 and SA2, skips step SA3 and proceeds to step SA4, then performs either step SA5 or step SA6. In step SA6 of the present embodiment, as described above, the display control unit 108A displays the second selection screen on each of the touch panels 13, 22, 23, and 24.

When one icon IC is selected by a touch operation on the selection screen G displayed by the touch panel 13, the content output unit 105 receives and outputs the content corresponding to the selected icon IC by at least one of the touch panel 13 and the speaker 25.

In addition, when one icon IC is selected by a touch operation on the selection screen G displayed by the touch panel 22, the content output unit 105 receives and outputs the content corresponding to the selected icon IC by at least one of the touch panel 22 and the speaker 26.

Further, when one icon IC is selected by a touch operation on the selection screen G displayed by the touch panel 23, the corresponding content output unit 105 receives and outputs the content corresponding to the selected icon IC by at least one of the touch panel 23 and the speaker 27.

Further, when one icon IC is selected by a touch operation on the selection screen G displayed by the touch panel 24, the corresponding content output unit 105 receives and outputs the content corresponding to the selected icon IC by at least one of the touch panel 24 and the speaker 28.

### 3. Other Embodiments

The embodiments described above merely indicate one aspect and arbitrary modifications and applications are possible.

In the embodiments described above, the case of a 4-seater vehicle 1 is exemplified. However, a passenger capacity of the vehicle 1 is not limited to four.

While a four-wheel vehicle 1 is exemplified in the embodiments described above, the number of wheels of the vehicle 1 is not limited to four.

While the touch panels 13, 22, 23, and 24 are exemplified as the “display unit” in the embodiments described above, the “display unit” is not limited to the touch panel, and may be a display that is operable with an operation key or the like without having a touch operation function.

While the vehicle display device 19 is not provided with the “display unit” in the embodiments described above, the vehicle display device 19 may be provided with the “display unit”.

While the icons IC are lined up in the left-right direction of the selection screen G in the embodiments described above, a line-up direction of the icons IC is not limited to the left-right direction and may be the up-down direction. In this other embodiment, displaying preferentially means displaying at an upper part for example.

On the selection screen G of the embodiments described above, the icons IC are listed in a separate row for each content supply source. On the selection screen G of another embodiment, the icons IC may be listed in N rows and M columns without separating the row for each content supply source. Note that N and M are integers equal to or larger than two. In the case of this other embodiment, displaying preferentially on the selection screen G means displaying as upward as possible as a first priority and displaying as far to the left as possible in one row as a second priority.

In the embodiments described above, the icon IC is displayed based on the traveling state of the vehicle 1 and matching of the target of the preference. In another embodiment, the icon IC may be displayed based on either one of the traveling state of the vehicle 1 and the matching of the target of the preference.

In the embodiments described above, the traveling state detection unit 107 detects the traveling state of the vehicle 1 based on a detection result of the shift position sensor 22. In another embodiment, a vehicle speed sensor may be provided in the vehicle 1 and the traveling state detection unit 107 may detect the traveling state of the vehicle 1 by the vehicle speed sensor.

In the embodiments described above, the passenger P is detected from the photographed images of the cameras 15, 17 and 18. In another embodiment, the passenger detection unit 106 may detect the passenger P by a method other than the photographed images of the cameras 15, 17 and 18. For example, when who is to get on is input to the vehicle display device 19 at the time of getting on, the passenger detection unit 106 may detect the passenger P by the input. Further, in another embodiment, when a microphone that collects voice of the passenger P is provided in the vehicle 1, the passenger detection unit 106 may detect the passenger P based on the number of pieces and kinds of the voice collected by the microphone. Further, in another embodiment, the passenger P seated in the driver's seat 10A may be detected by a FOB key.

In the embodiments described above, the seated position of the passenger P is detected from the photographed images of the cameras 15, 17 and 18. In another embodiment, the passenger detection unit 106 may detect the seated position of the passenger P by a method other than the photographed images of the cameras 15, 17 and 18. For example, when who is to sit in which seat is input to the vehicle display device 19 at the time of getting on, the passenger detection unit 106 may detect the passenger P by the input. Further, in another embodiment, the seated position of the passenger P may be detected based on the voice of the passenger P and a position of the microphone that most strongly collects the sound of the passenger P.

In the embodiments described above, the three application programs for utilizing the content are installed in the vehicle display device 19. In another embodiment, two or fewer or four or more application programs may be installed in the vehicle display device 19.

The processor 100 may be formed of a plurality of processors, or may be formed of one processor. The processor 100 may be hardware programmed to realize the functional units described above. In this case, the processors are formed of an ASIC (Application Specific Integrated Circuit) and an FPGA (Field Programmable Gate Array), for example.

Further, the configuration of the units of the vehicle 1 illustrated in FIG. 2 are only examples, and a specific mounting form is not limited in particular. That is, hardware individually corresponding to each unit does not need to be mounted, and it is also possible that one processor realizes functions of the respective units by executing a program. In addition, some of the functions realized by software in the embodiments described above may be hardware, or some of the functions realized by hardware may be realized by software.

Step units of the operation illustrated in FIG. 5 and FIG. 6 are divided according to main processing contents, and the present invention is not limited by a dividing method or a name of a processing unit. Division into further more step units may be performed according to the processing contents. Division may be also performed such that one step unit includes further more processing. Furthermore, the order of steps may be appropriately changed without interfering with the gist of the present invention.

Further, when a method of controlling the vehicle display device 19 described above is realized using the processor 100, the program to be executed by the processor 100 can be configured in a form of a recording medium or a transmission medium that transmits the program. That is, the control program 114 can be realized in a state of recording the control program 114 in a portable information recording medium. While examples of the information recording medium include a magnetic recording medium such as a hard disk, an optical recording medium such as a CD, and a semiconductor storage device such as a USB (Universal Serial Bus) memory and an SSD (Solid State Drive), other recording media can also be used.

### 4. Configurations Supported by Embodiments Described Above

The embodiments described above support the following configurations.

(Configuration 1) A vehicle display device including: a display control unit configured to display an icon indicating details of content available in a vehicle by a display unit provided inside the vehicle; a passenger detection unit configured to detect a passenger of the vehicle; and a storage unit configured to store passenger information regarding the passenger of the vehicle, wherein the display control unit acquires the passenger information corresponding to the passenger detected by the passenger detection unit from the storage unit, and displays the icon based on the acquired passenger information and content information regarding the content.

According to the vehicle display device of configuration 1, since the icon indicating the details of the content can be displayed in consideration of information regarding the passenger of the vehicle, the icon indicating the details of the content can be appropriately displayed according to the passenger of the vehicle.

(Configuration 2) The vehicle display device according to configuration 1, wherein the passenger information includes preference information indicating a target of preference, and when the passenger information of all of a plurality of passengers detected by the passenger detection unit is stored in the storage unit and there is a target of the preference that matches among the passengers detected by the passenger detection unit, the display control unit displays the icon based on the preference information indicating the target of the preference with the highest number of matches regarding one piece of the content.

According to the vehicle display device of configuration 2, since the icon indicating the details of the content preferred by the plurality of passengers can be displayed, utilization of the content can be accelerated for the plurality of passengers.

(Configuration 3) The vehicle display device according to configuration 1 or configuration 2, including a traveling state detection unit configured to detect a traveling state of the vehicle, wherein, when the passenger detection unit detects a plurality of passengers, the display control unit sets priority for displaying the icon for the plurality of pieces of passenger information acquired from the storage unit based on the traveling state of the vehicle detected by the traveling state detection unit, and displays the icon based on the set priority.

The passenger who is likely to utilize the content may be different depending on the traveling state of the vehicle. For example, when a driver is driving, the driver is less likely to utilize the content and the passengers other than the driver are likely to utilize the content on the other hand. Therefore, according to the vehicle display device of configuration 3, by setting the priority for displaying the icon based on the traveling state of the vehicle, the icon can be displayed according to the passenger who is likely to utilize the content depending on the traveling state of the vehicle. Thus, the icon indicating the details of the content can be appropriately displayed to the passenger of the vehicle, and utilization of the content can be promoted to the passenger who is likely to utilize the content.

(Configuration 4) The vehicle display device according to configuration 3, wherein, when the traveling state detection unit detects that the traveling state of the vehicle is a manual traveling state where the passenger seated in a driver's seat is manually driving, the display control unit sets the priority to be set for the passenger information of the passengers detected in seats other than the driver's seat to be higher than the priority to be set for the passenger information of the passenger detected in the driver's seat.

When the vehicle is in the manual traveling state, the driver of the vehicle is less likely to utilize the content. Therefore, according to the vehicle display device of configuration 4, the icon can be displayed according to the passenger who is likely to utilize the content in the manual traveling state.

(Configuration 5) The vehicle display device according to configuration 3 or configuration 4, wherein, when the traveling state detection unit detects that the traveling state of the vehicle is not the manual traveling state where the passenger seated in a driver's seat is not manually driving, the display control unit sets the priority to be set for the passenger information of the passenger detected in the driver's seat to be higher than the priority to be set for the passenger information of the passengers detected in seats other than the driver's seat.

The driver of the vehicle is likely to be an owner of the vehicle. Therefore, when the vehicle is not in the manual traveling state, the driver of the vehicle is likely to utilize the content. Therefore, according to the vehicle display device of configuration 4, the icon can be displayed according to the passenger who is likely to utilize the content when it is not the manual traveling state.

(Configuration 6) The vehicle display device according to any one of configuration 1 to configuration 5, wherein, when a passenger for whom the passenger information is not stored in the storage unit is included in the passengers detected by the passenger detection unit, the display control unit displays the icon without being based on the passenger information.

When the passenger for whom the passenger information is not stored is included in the passengers detected by the passenger detection unit, a passenger who does not usually get on the vehicle, such as a guest, may be included in the vehicle. Therefore, according to the vehicle display device of configuration 6, the passenger who does not usually get on the vehicle is suppressed from knowing what kind of content is the content according to the passenger who usually gets on the vehicle.

(Configuration 7) The vehicle display device according to any one of configuration 1 to configuration 6, wherein the vehicle is provided with the display unit for each seat, the passenger detection unit detects a passenger for each seat of the vehicle, and the display control unit acquires the passenger information for each seat of the vehicle, and displays the icon by the corresponding display unit based on the acquired passenger information for each seat of the vehicle.

When the plurality of display units are provided for each of the seats inside the vehicle, the passenger who utilizes the content at a certain display unit is likely to be the passenger seated in the seat corresponding to the certain display unit. Therefore, the vehicle display device of configuration 7 can display the icon indicating the details of the content in consideration of information regarding the passenger of the corresponding seat for each display unit. Therefore, even when the display unit is set for each seat, the icon indicating the details of the content can be appropriately displayed according to the passenger of the vehicle.

(Configuration 8) A method of controlling a vehicle display device including a storage unit configured to store passenger information regarding a passenger of a vehicle provided with a display unit, the method comprising: detecting the passenger of the vehicle; acquiring the passenger information corresponding to the detected passenger from the storage unit; and displaying an icon indicating details of content by the display unit based on the acquired passenger information and content information regarding the content available in the vehicle.

According the method of controlling a vehicle display device of configuration 8, an effect similar to that of the vehicle display device of configuration 1 is accomplished.

(Configuration 9) A non-transitory computer-readable storage medium storing a program that makes a processor of a vehicle display device including a storage unit configured to store passenger information regarding a passenger of a vehicle provided with a display unit function as a passenger detection unit configured to detect the passenger of the vehicle, and a display control unit configured to acquire the passenger information corresponding to the passenger detected by the passenger detection unit from the storage unit and to display an icon indicating details of content by the display unit based on the acquired passenger information and content information regarding the content available in the vehicle.

According to the program of configuration 9, an effect similar to that of the vehicle display device of configuration 1 can be accomplished.

### REFERENCE SIGNS LIST

1 . . . vehicle, 2 . . . content distribution server, 3 . . . icon distribution server, 4 . . . portable terminal, 10A . . . driver's seat, 10B . . . front passenger seat, 10C . . . rear right seat, 10D . . . rear left seat, 11A . . . right front door, 11B . . . left front door, 11C . . . right rear door, 11D . . . left rear door, 11E . . . tailgate, 12 . . . dashboard, 13, 22, 23, 24 . . . touch panel (display unit), 14, 25, 26, 27, 28 . . . speaker, 15, 17, 18 . . . camera, 16 . . . shift lever, 19 . . . vehicle display device, 20, 21 . . . communication device, 22 . . . shift position sensor, 100 . . . processor, 101 . . . first content output unit, 102 . . . second content output unit, 103 . . . third content output unit, 104 . . . fourth content output unit, 105 . . . content output unit, 106 . . . passenger detection unit, 107 . . . traveling state detection unit, 108, 108A . . . display control unit, 110 . . . memory, 111 . . . first APP, 112 . . . second APP, 113 . . . third APP, 114, 114A . . . control program (program), 115 . . . passenger DB, 1000 . . . content output system, A1 . . . list display area, G . . . selection screen, IC . . . icon, J1 . . . face feature amount information, J2 . . . preference information, J3 . . . content related information, J31 . . . name information, NW . . . network, P, P1, P2, P3, P4 . . . passenger, R1 . . . passenger information.

1. A vehicle display device comprising:
a display control unit configured to display an icon indicating details of content available in a vehicle by a display unit provided inside the vehicle;
a passenger detection unit configured to detect a passenger of the vehicle; and
a storage unit configured to store passenger information regarding the passenger of the vehicle,
wherein the display control unit acquires the passenger information corresponding to the passenger detected by the passenger detection unit from the storage unit, and displays the icon based on the acquired passenger information and content information regarding the content.

2. The vehicle display device according to claim 1,
wherein the passenger information includes preference information indicating a target of preference, and
when the passenger information of all of a plurality of passengers detected by the passenger detection unit is stored in the storage unit and there is a target of the preference that matches among the passengers detected by the passenger detection unit,
the display control unit displays the icon based on the preference information indicating the target of the preference with the highest number of matches regarding one piece of the content.

3. The vehicle display device according to claim 1, comprising
a traveling state detection unit configured to detect a traveling state of the vehicle,
wherein, when the passenger detection unit detects a plurality of passengers,
the display control unit sets priority for displaying the icon for the plurality of pieces of passenger information acquired from the storage unit based on the traveling state of the vehicle detected by the traveling state detection unit, and displays the icon based on the set priority.

4. The vehicle display device according to claim 3,
wherein, when the traveling state detection unit detects that the traveling state of the vehicle is a manual traveling state where the passenger seated in a driver's seat is manually driving,
the display control unit sets the priority to be set for the passenger information of the passengers detected in seats other than the driver's seat to be higher than the priority to be set for the passenger information of the passenger detected in the driver's seat.

5. The vehicle display device according to claim 3,
wherein, when the traveling state detection unit detects that the traveling state of the vehicle is not the manual traveling state where the passenger seated in a driver's seat is not manually driving,
the display control unit sets the priority to be set for the passenger information of the passenger detected in the driver's seat to be higher than the priority to be set for the passenger information of the passengers detected in seats other than the driver's seat.

6. The vehicle display device according to claim 1,
wherein, when a passenger for whom the passenger information is not stored in the storage unit is included in the passengers detected by the passenger detection unit,
the display control unit displays the icon without being based on the passenger information.

7. The vehicle display device according to claim 1,
wherein the vehicle is provided with the display unit for each seat,
the passenger detection unit detects a passenger for each seat of the vehicle, and
the display control unit acquires the passenger information for each seat of the vehicle, and displays the icon by the corresponding display unit based on the acquired passenger information for each seat of the vehicle.

8. A method of controlling a vehicle display device including a storage unit configured to store passenger information regarding a passenger of a vehicle provided with a display unit, the method comprising:
detecting the passenger of the vehicle;
acquiring the passenger information corresponding to the detected passenger from the storage unit; and
displaying an icon indicating details of content by the display unit based on the acquired passenger information and content information regarding the content available in the vehicle.

9. A non-transitory computer-readable storage medium storing a program that makes
a processor of a vehicle display device including a storage unit configured to store passenger information regarding a passenger of a vehicle provided with a display unit function as
a passenger detection unit configured to detect the passenger of the vehicle, and
a display control unit configured to acquire the passenger information corresponding to the passenger detected by the passenger detection unit from the storage unit and to display an icon indicating details of content by the display unit based on the acquired passenger information and content information regarding the content available in the vehicle.
